(19) United States
(12) Patent Application Publication
(10) Pub. No.: US 2005/0044040 A1
(43) Pub. Date: Feb. 24, 2005

(54) SYSTEM AND METHOD OF MEDIATING BUSINESS TRANSACTIONS

(76) Inventor: FRANK HOWARD, Kansas City, MO (US)

Correspondence Address: Gerhard P. Shipley, 4218 Roanoke Road,, Ste 305, Kansas City, MO, 64111, US

(21) Appl. No.: 10/604,830

(22) Filed: Aug. 20, 2003

(51) Int. Cl. G06F 17/60

(52) U.S. Cl. 705/40

(57) ABSTRACT

A system and method of mediating business transactions that allows purchasers to remain substantially anonymous by using negotiable stored-value or smart cards that allow for selectively withholding or transmitting the purchasers' personal information, while reducing risks to merchants by confirming payments substantially simultaneously with receipts of orders. More specifically, a mediator operating a transaction center is effectively interposed between the purchaser and merchant and receives the purchaser' order and payment information (e.g., card authentication information); verifies the validity of the card; and forwards the order and confirmation of payment to the merchant. The merchant can then safely fill and ship the order knowing that the payment has been confirmed and is substantially guaranteed.

### BACKGROUND OF INVENTION

1. Field of the Invention

The present invention relates broadly to systems and methods for facilitating business transactions, particularly ordering and payment activities. More particularly, the present invention concerns a system and method of mediating business transactions that allows purchasers to remain substantially anonymous by using negotiable stored-value cards or smart cards that allow for selectively withholding or transmitting the purchasers' personal information, while reducing risks to merchants by confirming payments substantially simultaneously with receipts of orders.

2. Description of Prior Art

It is becoming increasingly possible and popular to purchase goods or services over the Internet. Often, credit cards, debit cards, or other online payment systems are used to provide payment for these goods or services. These prior art payment systems, however, suffer from a number of problems and disadvantages of concern to both the purchaser and the merchant. One such problem involves a lack of communication security and, as a result, the purchaser's exposure to potentially large financial losses. Interception and theft of credit card or account information, for example, may expose the purchaser to losses as great as the associated line of credit or account balance.

Another problem involves the amount of personal information required by the prior art payment systems, and the accumulation and sale of purchase records associated with the personal information. More specifically, the service providers desire and insist upon developing an inseparable association between the purchaser and the purchases so that a permanent record can be created and subsequently sold to advertisers, merchants, and other third-parties.

Purchasers, however, are becoming increasingly wise to such tactics and, as a result, are in search of increased privacy and systems and methods for achieving such when making online purchases. It will be appreciated, for example, that individuals purchasing personal healthcare or medical supplies via the Internet will often wish to avoid the embarrassment and nuisance of other businesses learning of these purchases and sending, emailing, or telephoning advertisements for the same or similar products in an effort to win the purchaser's patronage. For businesses, the need for privacy may be much more acute. For example, distribution of a record of a company's purchases of goods or services may provide competitors with an indication of the company's activities, thereby potentially compromising the company's strategic business plans.

One method of avoiding the creation and distribution of such purchase records involves using prepaid or stored-value cards to make anonymous purchases. These cards are obtained having an associated monetary value which is thereafter reduced using a card reader/writer device each time a purchase is made. Unfortunately, current methods of affecting transactions using such cards suffer from a number of disadvantages, particularly from the perspective of the merchant. In the prior art, purchase transactions involve the merchant accepting the card as payment and then shipping the ordered item. In effect, the merchant makes the sale on credit and must later seek reimbursement from a third-party implementor or backer (e.g., a bank or other financial institution) of the card. It will be appreciated that this exposes the merchant to substantial risk of loss in that the stored-value card may not be honored by the third-party implementor for any number of reasons, including, for example, fraudulent tampering with the card, particularly the associated monetary value, by the purchaser. Given this risk, a large number of merchants may decide not to accept the stored-value card as payment, thereby undermining its use as a viable payment system.

Due to the above-mentioned and other problems and disadvantages of the prior art, a need exists for an improved payment system that allows purchasers to remain substantially anonymous while reducing or eliminating financial risk to merchants by confirming payments substantially simultaneously with receipt of orders.

### SUMMARY OF INVENTION

The above-described and other problems and disadvantages of the prior art are addressed by the present invention with a system and method for mediating business transactions. The present invention comprises a transaction mediation service provider (the “mediator”) using a transaction center adapted and operable to allow for mediating business transactions between a purchaser using a purchaser device for placing orders and a merchant using a merchant device for receiving orders, thereby enabling the purchaser to remain substantially anonymous while reducing the merchant's risk of loss by confirming payment substantially simultaneously with receipt of an order. The system and method of the present invention preferably make use of an improved stored-value or smart card.

The transaction center may take the form of a call center broadly including a plurality of telephone stations manned by operators, with each such station having a telephone and a computer terminal, and a central server hosting an account database and a merchant database. The account database contains information for authenticating or confirming the validity and remaining monetary value of any cards issued or otherwise honored by the mediator. The merchant database contains information for identifying merchants participating in the transaction mediation service and for transmitting payment confirmation and order information to these merchants. Alternatively, the center may include no or few telephones or operators, being instead substantially automated, wherein computers receive and process the purchasers' calls. In yet another alternative implementation, the center is web-based rather than telephone-based, such that purchaser-and-center and center-and-merchant communications occur via a communications network such as the Internet.

The card is adapted to store at least card authentication or identification information using a magnetic storage medium or smart chip. The monetary value associated with the card may be stored on the card itself or in the account database maintained by the center. No personal information about the purchaser need by obtained or stored. More specifically, the card need not be in any way associated with the purchaser, making it a highly negotiable instrument. So long as the card itself can be authenticated, the mediator needs no other information in order to confirm payment for the merchant. Where the purchaser desires to remain as anonymous as possible, the purchaser's device used to contact the center and place the order may be an unassociatable or common-usage device such as, for example, a public telephone or library computer, and the shipping address given for the order may be that of a third-party mail-receiving service. Where it is desirable to allow for storing the purchaser's name, shipping address, or other personal information on the card, a selection mechanism is provided that allows the purchaser to transmit or withhold this personal information as desired.

In operation, the center is effectively interposed between the purchaser and merchant and acts as an intermediary that receives the purchaser's order and payment information (e.g., card authentication information); verifies the validity of the card; and forwards the order and confirmation of payment to the merchant. The merchant can then safely fill and ship the order knowing that the payment has been confirmed and is guaranteed.

Thus, it will be appreciated that the present invention provides a number of substantial advantages over the prior art, including, for example, enabling purchasers to remain substantially anonymous while reducing the merchant's risk of loss by confirming payment substantially simultaneously with receipt of an order. This is accomplished in part by interposing the mediator between the purchaser and merchant rather than requiring, as the prior art does, the merchant to deal directly with the purchaser and, in effect, make sales on credit and hope to be later reimbursed. More specifically, in the present invention the purchaser communicates order and payment information to the mediator, who is then able to confirm payment when forwarding the order to the merchant, thereby reducing or eliminating the merchant's risk of loss. This, in turn, makes more merchants more likely to participate in the mediator's service and accept the cards.

Furthermore, the card advantageously provides a highly negotiable instrument for payment that further enhances purchaser privacy by allowing for selectively associating or disassociating purchasers' personal information from purchases. For purchases for which it is desirable to transmit personal information, the present invention provides the extremely advantageous feature of selective enablement, allowing the purchaser to easily determine for each purchase whether to withhold or transmit the personal information.

These and other important features of the present invention are more fully described in the section titled DETAILED DESCRIPTION OF A PREFERRED EMBODIMENT, below

### BRIEF DESCRIPTION OF DRAWINGS

A preferred embodiment of the present invention is described in detail below with reference to the attached drawing figures, wherein:

FIG. 1 is a diagram of a system for mediating business transactions in accordance with a preferred embodiment of the present invention;

FIG. 2 is a depiction of a stored-value or smart card for use with the system of FIG. 1; and

FIG. 3 is a flowchart of preferred steps involved in a method of mediating transactions using the system of FIG. 1 and the card of FIG. 2.

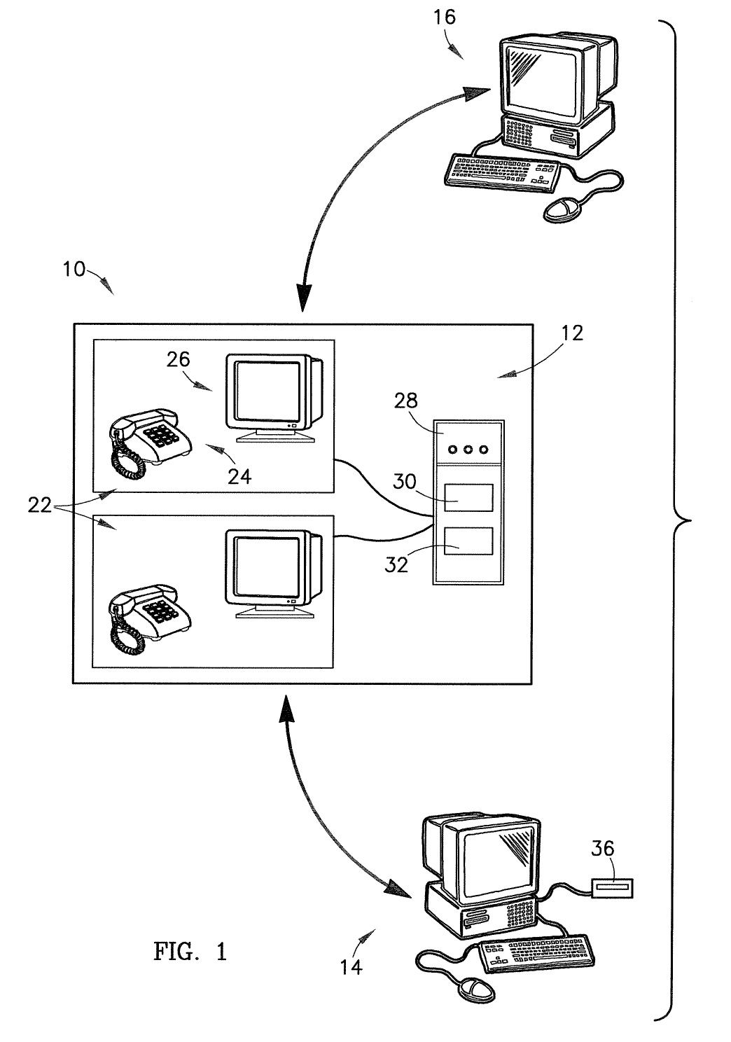

### DETAILED DESCRIPTION

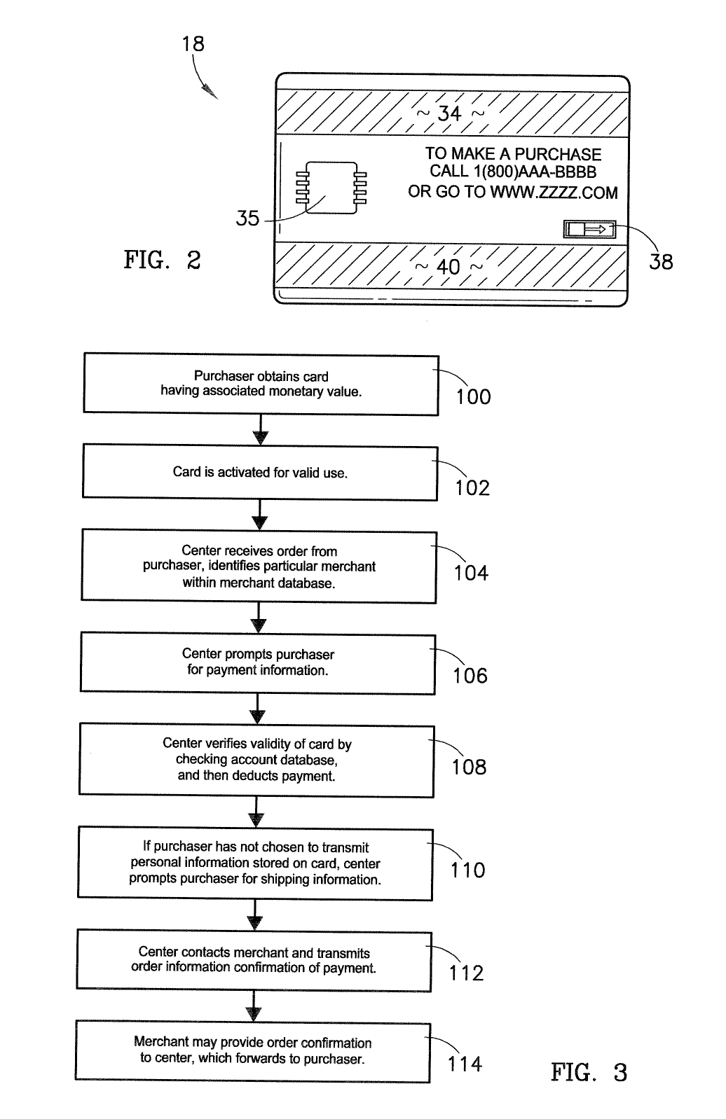

With reference to the figures, a system 10 and method for mediating business transactions is herein described and disclosed in accordance with a preferred embodiment of the present invention. The system 10 comprises a transaction mediation service provider (the “mediator”) using a transaction center 12 adapted and operable to allow for mediating business transactions between a purchaser using a purchaser device 14 for placing orders and a merchant using a merchant device 16 for receiving orders, thereby enabling the purchaser to remain substantially anonymous while reducing the merchant's risk of loss by confirming payment substantially simultaneously with receipt of an order. The system 10 and method of the present invention preferably make use of a stored-value or smart card 18, shown in FIG. 2, for facilitating payment by the purchaser.

The transaction center 12 may, in one contemplated implementation, take the form of a call center broadly including a plurality of telephone stations 22 manned by operators, with each such station having a telephone 24 and a computer terminal 26, and a central server 28 hosting an account database 30 and a merchant database 32. The account database 30 contains information for authenticating or confirming the validity and remaining monetary value of any cards 18 issued or otherwise honored by the mediator. The merchant database 32 contains information for identifying merchants participating in the transaction mediation service and for transmitting payment confirmation and order information to these merchants. In this implementation, the center 12 is preferably associated with one or more telephone numbers, whether tolled or toll-free, that the purchaser may use to contact the center 12. For the purchaser's convenience, this telephone number may appear on the card 18. The center 12 may also include a switchboard (not shown) or other technology for receiving, queuing, and routing the purchasers' calls to the telephone stations 22.

In another contemplated implementation, the center includes no or few telephones or operators, but is instead substantially automated, wherein computers receive and process the purchasers' calls. In yet another contemplated implementation, the center is web-based rather than telephone-based, such that the purchaser contacts the center and the center communicates with the merchant via a network such as the Internet. Thus, it will be appreciated that the center 12 may be implemented in any of the aforementioned manners or any combinations thereof or in any other suitable manner.

It will also be appreciated that the nature of the purchaser's device 14 will depend upon the manner(s) in which the center 12 is implemented. If telephone-based, for example, then the purchaser's device 14 may be substantially any conventional or otherwise suitable landline or wireless telephone; if computer-based, then the purchaser's device 14 may be substantially any computing device, such as a desktop, laptop, or hand-held computer, operable to access the Internet. Regardless of how the center 12 is implemented, however, the merchant's device 16 will likely be a computing device operable to receive payment confirmation and order information from the center 12 via the Internet.

As mentioned, the system 10 and method of the present invention preferably make use of the aforementioned card 18. The card 18 is adapted to store at least card authentication or identification information (e.g., an alphanumeric identifier) using, for example, a magnetic storage medium 34 or smart chip 35. In one contemplated implementation, the actual monetary value associated with the stored-value card 18 is also stored on the magnetic storage medium 34 or smart chip 35. The card 18 may include security features, including, for example, encryption in order to minimize or prevent tampering with the monetary value or other stored information. The purchaser's device 14 may include a card reader/writer device 36 adapted to allow the center 12 to remotely access the magnetic storage medium 34 or smart chip 35 in order to read and confirm the card authentication or identification information and to debit any payment amount from the stored monetary value. If the card 18 is disposable in nature, then it may only be debited; however, if the card 18 is reusable in nature, then the monetary value may also be increased by the center 12 or an authorized agent thereof using the card reader/writer device 36. Alternatively, rather than using the card reader/writer device 36, the center 12 may simply prompt the user to enter, speak, or otherwise provide the authentication or identification.

In another contemplated implementation, the associated monetary value is stored in an account in the account database 30 mentioned above, rather than on the card 19 itself. In this implementation, the card reader/writer device 36 is used only to read and confirm the card authentication or identification information and to identify the account associated therewith. Any payments are debited from the monetary value stored in the account. As mentioned, if the card/account is reusable in nature, then the monetary value in the account may be increased as desired. It will be appreciated that storing the monetary value in an account in the account database 30 rather than on the card 18 itself may allow for greater control by the mediator and less opportunity for tampering.

It will also be appreciated that no personal information about the purchaser need by obtained or stored. The card 18 need not be in any way associated with the purchaser, making it a highly negotiable instrument. So long as the card 18 itself can be authenticated, the mediator needs no other information in order to confirm payment for the merchant. Where the purchaser desires to remain as anonymous as possible, the purchaser's device 14 used to contact the center 12 and place the order may be an unassociatable or common-usage device such as, for example, a public telephone or library computer, and the shipping address given for the order may be that of a third-party mail-receiving service.

Where it is desirable to allow for storing the purchaser's name, shipping address, or other personal information on the card 18, such information may also be stored on the magnetic storage medium 34 or smart chip 35. Preferably, a selection mechanism 38 is provided that allows the purchaser to transmit or withhold this personal information, as desired. The selection mechanism 38 may take the form of a mechanical sliding switch on the card 18 itself or on the card reader/writer device 36, or may take the form of a software-based virtual switch provided by software stored on the purchaser's device 14. In an alternative or additional implementation, a second magnetic storage medium 40 may be provided on the card 18, with the first magnetic storage medium 34 being limited to storing only non-personal information and the second magnetic storage medium 40 storing only personal information or both non-personal and personal information. In this case, the purchaser selects whether to withhold or transmit any personal information by purposefully orienting the card 18 within the card reader/writer 36 so as to result in either the first or second magnetic storage mediums 34,40, respectively, being accessed. This feature advantageously allows the purchaser to decide at the time of purchase whether to withhold or transmit information and thereby maintain or forego privacy as desired, depending, for example, on such considerations as the nature of the goods or services being purchased. Where personal information is withheld, the purchaser may be prompted to enter, speak, or otherwise provide a shipping address; but where personal information is transmitted, such information may include the shipping address.

In exemplary use and operation, the method of the present invention proceeds as follows. The purchaser, anticipating making a purchase from a remote merchant, obtains the card 18 having an associated monetary value, as depicted in box 100. It is contemplated that the card 18 may be sold by any number of retail outlets, including, for example, convenience stores and grocery stores, possibly though vending machines. The card seller may be required to activate the card 18 so that it may be validly used by the purchaser, as depicted in box 102. Such activation may involve, for example, contacting the mediator or the account database directly. The purchaser may then identify the item he or she wishes to order from, e.g., a catalog, advertisement, or website maintained by the merchant.

The purchaser then, using the purchaser's device 14, contacts the transaction center 12 to place the order. The center 12 accepts the order after identifying the particular merchant within the merchant database 32, as depicted in box 104. The center 12 then prompts the purchaser for payment information, as depicted in box 106. Depending on the manner in which the card 18 is implemented, providing payment information may involve inserting the card 18 into the card reader/writer device 36 so that the authentication or identification information can be read and transmitted to the center 12. The center 12 may verify the validity of the card 18 and the remaining monetary value associated with it by checking the account database 30, and then deduct the payment from an account associated with the card 18 or deduct the payment from the card 18 itself by sending a corresponding signal to the card reader/writer device 36, as depicted in box 108. If the purchaser has not chosen to automatically transmit personal information stored on the card 18, the purchaser will be prompted to provide a shipping name and address, as depicted in box 110.

The center 12 then contacts the appropriate merchant using the merchant's device 16 and transmits the order information and confirmation of payment, as depicted in box 112. Such confirmation may involve the center's assurance that it has verified the card 18 used to make payment and therefore guarantees that the merchant will be paid. The merchant may provide an order confirmation to the center 12 that is forwarded to the purchaser, as depicted in box 114. Such an order confirmation may include an order identification number or tracking number that can be used by the purchaser to communicate with the merchant regarding the status of the order. The merchant can then safely fill and ship the order, assured that payment, if not already actually received has been confirmed and will be forthcoming.

The mediator, it will be appreciated, may be compensated for its services in facilitating the business transaction between the purchaser and the merchant under any one or more of a variety compensation schemes. More specifically, the mediator may receive compensation from a surcharge paid by the purchaser when purchasing a card 18; from a one-time or periodic membership fee paid by the participating merchants; from a surcharge added to each purchase, perhaps being based upon the amount of purchase (e.g., 0.5% or 1% of the purchase total), which is either added to the bill and paid by the purchaser or passed to the merchant; from interest earned on money received from purchasers in return for cards but not yet spent by purchasers; or from interest earned on payments received from purchasers and confirmed to merchants but not yet paid to merchants.

From the preceding description, it will be appreciated that the present invention provides a number of substantial advantages over the prior art, including, for example, enabling purchasers to remain substantially anonymous while reducing the merchant's risk of loss by confirming payment substantially simultaneously with receipt of an order. This is accomplished in part by interposing the mediator between the purchaser and merchant rather than requiring, as the prior art does, the merchant to deal directly with the purchaser and, in effect, make sales on credit and hope to be later reimbursed. More specifically, in the present invention the purchaser communicates order and payment information to the mediator, who is then able to confirm payment when forwarding the order to the merchant, thereby reducing or eliminating the merchant's risk of loss. This, in turn, makes more merchants more likely to participate in the mediator's service and accept the cards.

Furthermore, the stored-value or smart card advantageously provides a highly negotiable instrument for payment that further enhances purchaser privacy by allowing for selectively associating or disassociating purchasers' personal information from purchases. For purchases for which it is desirable to transmit personal information, the present invention provides the extremely advantageous feature of selective enablement, allowing the purchaser to easily determine for each purchase whether to withhold or transmit the personal information.

Although the invention has been described with reference to the preferred embodiments illustrated in the attached drawings, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A method of mediating a business transaction, the method comprising the steps of:
(a) providing a transaction center to act as a third-party intermediary between a purchaser and a participating merchant;
(b) receiving at the transaction center order information from the purchaser;
(c) receiving at the transaction center payment information from the purchaser;
(d) verifying the payment information; and
(e) forwarding the order information to the participating merchant and substantially simultaneously confirming payment to the participating merchant.

2. The method as set forth in claim 1, further including the steps of
receiving an order confirmation from the participating merchant; and
forwarding the order confirmation to the purchaser.

3. The method as set forth in claim 1, further including the steps of
providing a card for use by the purchaser to make the payment; and
verifying a validity of the card.

4. The method as set forth in claim 3, wherein the card is associated with a monetary value, the method further including the step of
verifying the monetary value; and
debiting the monetary value by an amount substantially equal to the payment.

5. A method of mediating a business transaction, the method comprising the steps of:
(a) providing a transaction center to act as a third-party intermediary between a purchaser and a participating merchant;
(b) providing a card for use by the purchaser to make the payment, wherein the card is associated with a monetary value;
(c) receiving at the transaction center order information from a purchaser;
(d) receiving at the transaction center payment information from the purchaser, wherein the payment information is associated with the card;
(e) verifying a validity of the card, verifying the monetary value, and debiting the monetary value by an amount substantially equal to the payment; and
(f) forwarding the order information to the participating merchant and substantially simultaneously confirming payment to the participating merchant.

6. The method as set forth in claim 5, further including the steps of
receiving an order confirmation from the participating merchant; and
forwarding the order confirmation to the purchaser.

7. The method as set forth in claim 5, wherein the card includes
a storage medium for storing non-personal information including an encrypted authentication number for verifying a validity of the card, and for storing personal information including a name and a shipping address for the purchaser; and
a selection mechanism for allowing the purchaser to selectively withhold or transmit the personal information stored on the card.

8. The method as set forth in claim 7, wherein the selection mechanism is a mechanical sliding switch provided on the card.

9. The method as set forth in claim 7, wherein the stored information further includes the monetary value associated with the card.

10. The method as set forth in claim 7, wherein the card is associated with a remotely maintained account wherein is stored the monetary value associated with the card.

11. A method of mediating a business transaction, the method comprising the steps of:
(a) providing a transaction center to act as a third-party intermediary between a purchaser and a participating merchant;
(b) providing a card for use by the purchaser to make the payment, wherein the card is associated with a monetary value and includes
a storage medium for storing non-personal information including encrypted authentication information for verifying a validity of the card, and for storing personal information including a name and a shipping address for the purchaser, and
a selection mechanism for allowing the purchaser to selectively withhold or transmit the personal information stored on the card;
(c) receiving at the transaction center order information from a purchaser;
(d) receiving at the transaction center payment information from the purchaser, wherein the payment information is associated with the card;
(e) verifying a validity of the card, verifying the monetary value, and debiting the monetary value by an amount substantially equal to the payment; and
(f) forwarding the order information to the participating merchant and substantially simultaneously confirming payment to the participating merchant;
(g) receiving an order confirmation from the participating merchant; and
(h) forwarding the order confirmation to the purchaser.

12. A card for use by a purchaser to affect payment during a business transaction, the card comprising:
a storage medium for storing non-personal information including an encrypted authentication number for verifying a validity of the card, and for storing personal information including a name and a shipping address for the purchaser; and
a selection mechanism for allowing the purchaser to selectively withhold or transmit the personal information stored on the card.

13. The card as set forth in claim 12, wherein the selection mechanism is a mechanical sliding switch provided on the card.

14. The card as set forth in claim 12, wherein the stored information further includes a monetary value associated with the card.

15. The card as set forth in claim 12, wherein the card is associated with a remotely maintained account wherein is stored a monetary value associated with the card.

16. A card for use by a purchaser to affect payment during a business transaction, the card comprising:
a first storage medium for storing non-personal information including an encrypted authentication number for verifying a validity of the card; and
a second storage medium for storing personal information including a name and a shipping address for the purchaser,
wherein when making payment the purchaser selectively uses the first storage medium or second storage medium and thereby withholds or transmits, respectively, the personal information stored on the card.

17. The card as set forth in claim 16, wherein the selection mechanism is a mechanical sliding switch provided on the card.

18. The card as set forth in claim 16, wherein the stored information further includes a monetary value associated with the card.

19. The card as set forth in claim 16, wherein the card is associated with a remotely maintained account wherein is stored a monetary value associated with the card.
